(19) United States
(12) Patent Application Publication
(10) Pub. No.: US 2015/0331869 A1
(43) Pub. Date: Nov. 19, 2015

(54) METHOD AND SYSTEM ALLOWING USERS TO EASILY CONTRIBUTE TO A SOCIAL COMPOSITION

(71) Applicant: Brian LaRoy Berg, Agoura Hills, CA (US)

(72) Inventor: Brian LaRoy Berg, Agoura Hills, CA (US)

(21) Appl. No.: 14/279,249

(22) Filed: May 15, 2014

(51) Int. Cl. G06F 17/30; G06F 3/0484

(52) U.S. Cl. CPC G06F 17/30056; G06F 3/04847

(57) ABSTRACT

A networked, electronic system and method allows users to generate their own media layer for automatic availability to other users as an independent piece, or as a social composition created by combining the user's media layer with other specified layers. The user may initially choose the desired media layer(s) previously recorded, as well as simple control specifications to guide the synchronization of how the user's recorded media layer data is aligned with the specified media layer(s). Then, through standard inputs that control the level of contribution of each media layer, user settings are collected whenever each layer combination is played, and used to develop a social composition.

### RELATED APPLICATIONS

This application claims the benefit of U.S. Provisional Application No. 61/824,950, filed May 17, 2013.

### BACKGROUND

Some of the software packages that enable collaboration of informational content among networked users, such as IBM Lotus Notes, Microsoft Sharepoint, Webex WebOffice, Softalk Collaboration Suite, and Google Docs, were initially introduced even before the current millennium. However, there has been a resurgence in collaboration tools in recent years provided as web applications, as exemplified by Wikis, such as Wikipedia, ScholarPedia, and Citizendium; by Blogs, such as those found on Blogger, and by social media sites such as Twitter, Google+, and Facebook. The collaborative content development process of current open services has been referred to as Social Darwinism. As explained under the “wiki” topic in Wikipedia at the time of this writing, “‘Unfit’ sentences and sections are ruthlessly culled, edited and replaced if they are not considered ‘fit’, which hopefully results in the evolution of a higher quality and more relevant page.” Although these online services often provide some type of version control, previous versions of content are not readily visible and are susceptible to being disregarded indefinitely after subsequent contributors decide it should be “culled”. This results in a problem commonly referred to as “information decay”.

Another category of collaboration services has also emerged for creative and artistic content, such as music, video, movies, stories, etc. For example there are systems for creating community stories (Wiki stories) that are stories written by multiple participants with text-based co-creative effort. There are also web-based solutions for generating simple animated scenarios wherein users choose settings, time, characters, dialog and/or music. Finally, there are “Cinema 2.0” efforts that are more sophisticated efforts at crowd sourced script generation and video coverage in order to assemble a linear movie-type experience online that allow users to bypass high budget productions. Although the goal of the resulting collaborative content in these cases has less to do with informational accuracy and more about creating media (often multimedia) content that appeals to the senses, specific rules or specifications are still used in these systems to follow a specific plot, genre, demographic or general qualities of traditional (non-collaborative) music, videos, movies, etc.; thus inhibiting truly democratic content creation. Furthermore, these systems suffer from the same limitations as those used in informational content collaboration described previously.

The information decay resulting from the aforementioned systems is particularly serious in that lost or hidden material is rarely removed or archived in a democratic way, but commonly by a single user. Even with multiple users involved, this process is shortsighted from the standpoint that it is not conducive to the resurrection of previously hidden information when new users join or perspectives change perhaps making that information more relevant. For the foregoing reasons, there is a need for a method or system that conveniently allows the creation of content in a more democratic manner but avoids cluttering the collaborative composition with an overload of information.

### SUMMARY

The present invention is directed to a networked electronic system and method that conveniently enables the creation of social media of high interest while fostering true collaboration; giving novice social media developers greater opportunity to have their work noticed and express themselves more widely and democratically, without falling victim to the “information decay” problem.

The networked electronic system and method comprises a recorder that allows users to capture their own media content (also referred to herein as a “layer”), perhaps semi-synchronously with, but perceptually isolated from, a previously recorded media layer. The method and system automatically makes the recorded layer, or transformed representation thereof, available to other users to output through a player as an independent piece, or with other layers as a social composition through a combiner that uses dynamic weighting as a perceptual scaler, and aligning, as determined democratically by all users, perhaps with averaged numerical ratings that provide a collaborative score for the set of content between each of the media layers for the linear combination thereof.

Since each recorded media layer is perceptually isolated from each other, the scaling and shifting of each layer performed by this invention can be controlled independently of the other layers. The other advantage of isolating media layers is that it alleviates potential copyright and ownership conflicts. The present invention is suited for large-scale participation as new contributors can contribute their media layer, knowing that it will always be available in the resulting social composition and emphasized over content in other media layers collectively considered less interesting to the community of collaborators.

These and other features, aspects, and advantages of the present invention will become better understood with regard to the following description, appended claims, and accompanying drawings.

### BRIEF DESCRIPTION OF THE DRAWINGS

FIG. 1 is a block diagram of a method according to an embodiment of the invention for the output and collaborative creation of social media in an overlayed, semi-synchronous manner.

FIG. 2 is a block diagram of a method according to an embodiment of the invention for providing user control (130) of the combiner component (160 in FIG. 1).

FIG. 3 is a block diagram of a method according to an embodiment of the invention for performing the combiner operation (160) according to a linear combination of media layers.

FIG. 4 is a flow diagram illustrating the operation of an exemplary system in accordance with an embodiment.

### DETAILED DESCRIPTION AND PREFERRED IMPLEMENTATION

As used herein, “data,” “content,” “information” and similar terms may be used interchangeably to refer to data capable of being recorded, played and/or stored in accordance with embodiments of the present invention. The term “user” is an individual using the invention to create and/or consume content from the network or system. The “collaborators” or “community” or similar terms may be used interchangeably to refer to the group of users that share and create content together.

Also used herein, the term “media” can be almost any kind of content; audio, video, multimedia, etc., for example a song, a book, a newspaper or magazine article, a movie, a piece of a radio program, etc. Generally, in the digital media called “multimedia”, pictures are presented along with sounds corresponding thereto. Therefore, personal computers are generally used, for the time being, as an apparatus for presenting pictures along with sound. However, it is expected in the future that new computer systems with media support will be extended to support other senses such as touch, smell, etc.

Also used herein, the term “media layer” is a sequence of digital media data such as video or audio or any media or combination thereof that is captured from a recorded source or provided by a member of the community for consumption by other community members. Meanwhile, while experiencing the media layer, a plurality of group members may discuss the content or other topics by providing text, audio and/or video commentary (e.g., in the form of social media) or share their own expression of the media layer to be combined with the media layer to form what shall be termed a “social composition” herein.

With the growing quantity of user-generated content and the demand for a “shared experience” of social media, there is a deficiency of tools that allow people to easily and democratically share in the creation of social media; especially for the large population of novice social media developers who may be at least as interested in a content creation method that's fair and democratic as they are in one that results in content of professional quality. This is particularly challenging with multimedia, which can contain a great deal of information and evoke a lot of emotion at various times throughout its presentation. Several exemplary versions of the invention are presented below, including those that demonstrate the applicability of this invention to multimedia and other types of social media.

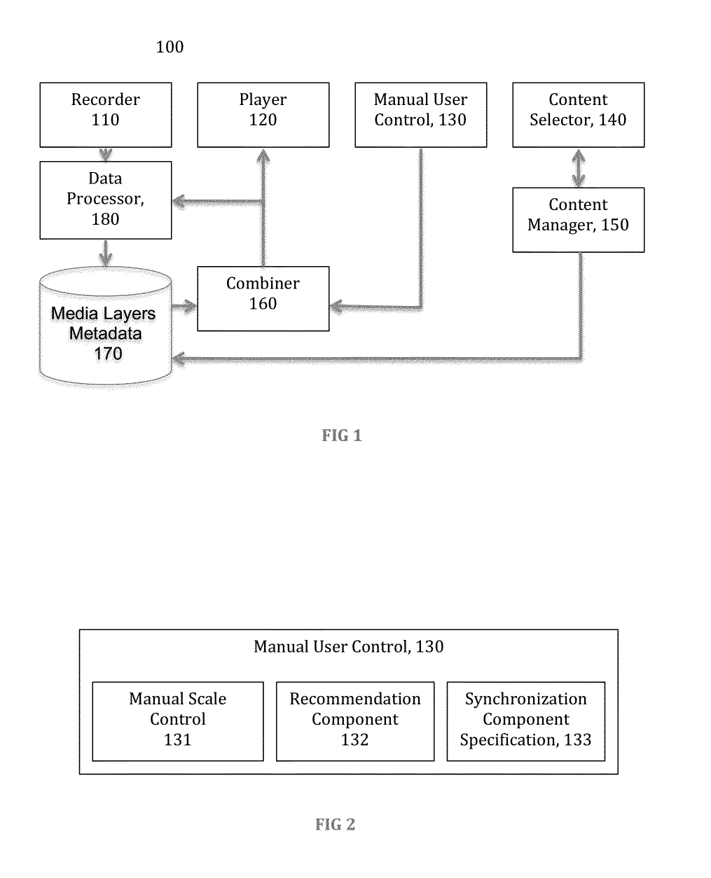

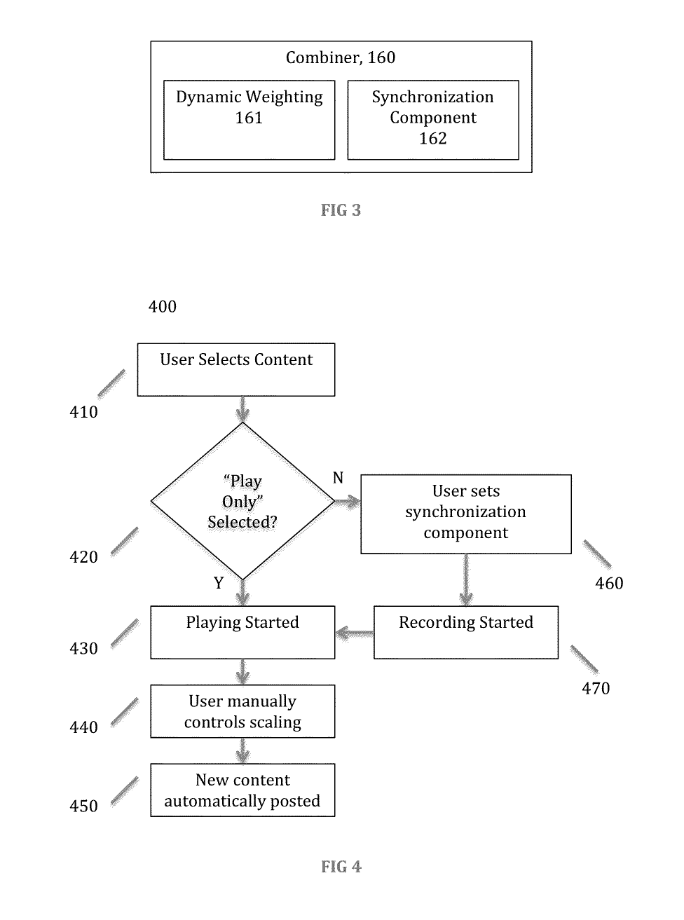

FIG. 1 is a block diagram illustrating a method for sharing in the consumption and/or creation of social media in accordance with a preferred embodiment of the present invention. FIG. 2 is a block diagram illustrating a method allowing users to guide the combination process of the social composition in accordance with a preferred embodiment. FIG. 3 is a block diagram illustrating a method of the combination process including weighting and synchronization operations in accordance with a preferred embodiment.

Referring to FIG. 1, an illustrative embodiment of a social media tool that may be used for sharing in the consumption and/or creation of social media is illustrated and is generally designated 100. As shown, the system 100 can include a recorder 110, a player 120, manual user controls 130, content selector 140, content manager 150, combiner 160, media layer and metadata storage 170, and a data processor 180.

An illustrative embodiment may allow a user to create an initial media layer with the recorder 110 (or record it elsewhere and make it available to the invention) to be played back or output in some way with the player 120 by other users on the network, or played back while a user records another media layer with the recorder 110; keeping this new layer independent with no perceived interference from the initial media layer (perhaps requiring some type of filtering operation within the data processor 180). Subsequent media layers can be recorded with the recorder 110 while playing any existing media layer or any overlaid, perceptually scaled combination, accessing the media layers and metadata 170 and processing in the combiner 160, as specified by the user recording the new media layer via the content selector 140 made available by the content manager 150. Users may not be given the capability to edit media layers owned by others, but the system might allow users to recommend or vote on scaling and synchronization variations at one or more time instances within each media layer owned by other users via the manual user controls 130. The manual user controls 130 might also allow the media layer owner to specify a value or range of scaling and synchronization values that the owner will allow the media layer to be varied during playback. These aspects of the present invention will become better understood with the following description and accompanying drawings.

In an embodiment, the recorder (110) generally represents the operation of capturing a media layer, as an input from the user. A preferred embodiment may involve the capture of text as entered by a keyboard (e.g.; containing a story or instructions, etc.). The recorder (110) of a preferred embodiment may also involve the capture of audio from a microphone to an mp3 file, and/or video from a webcam or software program to an avi file (or graphical visualizations or animations or any time-series of image frames). In addition to media layers, the recorder (110) may also capture metadata such as the user's location, social network profile including size of network, previously created media layers and their ratings, etc. Depending upon the application, it may be acceptable to prompt the user for additional information. For example there may be metadata that the user can enter to specify who has access to their recorded media layers and who is allowed to include it in their social compositions. An example describing a specific recorder (110) should not be construed as limited to that recorder.

In an embodiment, the player (120) generally represents the operation of outputting a sequence of digital media data to the user. A preferred embodiment may involve the display of a sequence of text (e.g.; containing a story or instructions, etc.). The player (120) of a preferred embodiment may also involve audio sent to a speaker. Since one goal is to prevent interference of media layers while eliminating the information decay problem, an embodiment might involve the use of multiple speakers to conveniently listen to all layers. The player (120) of a preferred embodiment may involve video or animations output to the display of a computer or mobile device. Since one goal is to prevent interference of media layers while eliminating the information decay problem, an embodiment might involve the use of multiple display windows to conveniently view all layers. An example describing a specific player (120) should not be construed as limited to that player.

In an embodiment, the manual user control (130) may generally represent the operation of guiding the combiner process. As shown in FIG. 2, a preferred embodiment may include a manual scale control (131) for scaling the i^{th} media layer. The manual scale control (131) of a preferred embodiment may involve a font size selection for textual media data (e.g.; containing a story or instructions, etc.), where users may dynamically adjust font sizes of each row within a block of text, where each row may correspond to a recorded text file layer. The manual scale control (131) of a preferred embodiment may involve a gain control for audio media. The manual user control (131) of a preferred embodiment may involve alpha or transparency control for video or animations (perhaps to fade between media layers). An example describing a specific manual scale control (131) should not be construed as limited to that manual scale control.

As shown in FIG. 2, a preferred embodiment of the manual user control (130) may include a recommendation component (132) for rating the i^{th} media layer. The recommendation component (132) of a preferred embodiment may involve a simple, binary vote of yes/no or like/dislike. The recommendation component (132) of a preferred embodiment may involve a numbered rating like the common 5-star system. An example describing a specific recommendation component (132) should not be construed as limited to that recommendation component.

As shown in FIG. 2, a preferred embodiment of the manual user control (130) may include a synchronization specification component (133). The synchronization specification component (133) of a preferred embodiment may involve a numerical input corresponding to a time delay/advancement between various image frames within video, or graphical visualizations, or animations or any time-series of image frames, to pause or advance the playback of the various video layers while attempting to minimize interference between them; thus allowing more layers to be conveniently observed. The synchronization specification component (133) of another preferred embodiment may involve content descriptors that correspond to different thresholds of synchronization variation. For example instructional content (such as cooking/recipe creation, mathematical derivations, writing computer code, etc.) might require more strict synchronization then artistic content (such as creating a painting or computer generated animations). The combiner 160 may then automatically determine optimal synchronization parameters according to some application-specific criteria. For large scale applications, a preferred manual user control (130) embodiment for more tractable media layer specification management might involve the user control of several subsets of media layers (such as sub-networks within social networks or at different time instances, or snapshots of time of the social composition) prior to combining all available media layers for a given content. For example, a preferred manual user control 130 may locate segments of silence in an audio media layer to be delayed or advanced such that it overlays with audio segments of non-silence within other audio media layers. An example describing a specific synchronization specification component (133) should not be construed as limited to that synchronization specification component.

In an embodiment, the content selector (140) allows a user to select the desired media layer to play and synchronize to for recording. This selection may be entered with a keyboard into a computer or by selecting a link using a mouse or a finger on a touchscreen or any gesture input. The content selector (140) of a preferred embodiment may allow the selection of a media layer previously recorded with this invention. The content selector (140) may allow the selection of a social composition of several media layers recorded with this invention. The content selector (140) of a preferred embodiment may allow the selection of media found in networked storage such as on the web. An example describing a specific content selector (140) should not be construed as limited to that content selector.

In an embodiment, the content manager (150) automatically provides visibility to users into the availability of media layers that have been recorded and stored in the database, and provides access to the appropriate layer(s) stored in the database according to the user specification for the content selector (140). The content manager (150) of a preferred embodiment may involve a music listing on a web page. The content manager (150) of a preferred embodiment may involve a movie listing from a streaming site. The content manager (150) of a preferred embodiment may involve users profiles from a social networking site. An example describing a specific content manager (150) should not be construed as limited to that content manager.

In an embodiment, the combiner (160) is where social compositions are generated for the player (120). As shown in FIG. 3, a preferred embodiment may include a dynamic weighting (161) wᵢ(n) as a function of time sampling points, n for the ith media layer. The dynamic weighting (161) used in the combiner for a particular social composition may be a function of the manual scale control (131) as set by one or more users having previously played the media layer(s). The dynamic weighting (161) used in the combiner for a particular social composition may be a function of the recommendation component (132) as set by one or more users having previously played the media layer(s) to serve as a collaborative scoring. For example media layer within which high scales and/or high recommendation ratings were consistently awarded might result in higher dynamic weights wᵢ(n). A preferred embodiment of the dynamic weighting (161) might average font sizes recommended by all users for each recorded text media layer (e.g.; containing a story or instructions, etc.). A preferred embodiment of the dynamic weighting (161) might average image transparency recommendations (perhaps to fade between video recordings) for all users when overlaying each of the avi media layers. A preferred embodiment may allow users to record metadata (110) that results in a different weighting for the recommendations of specific users according to their experience, rankings of their own media layers, geo-location, etc. An example describing a specific dynamic weighting (161) should not be construed as limited to that dynamic weighting (161).

As shown in FIG. 3, a preferred embodiment of a combiner (160) may include a synchronization component (162) to produce a time offset Tᵢ(n) at a given sample for the i^{th} media layer. The synchronization component (162) of a preferred embodiment may be a function of the synchronization component specification (133). For the composition of N media layers {mᵢ(n)} for i=0, 1, . . . N−1 the output of a preferred embodiment of a combiner (160) at a particular time instant n may be a function of a linear combination Σᵢ₌₀^{N-1}wᵢ(n)*mᵢ(n−Tᵢ(n)). An example describing a specific recommendation component (162) should not be construed as limited to that recommendation component.

In an embodiment, the media layer and metadata storage unit (170) represents the data storage function. The media layer and metadata storage unit (170) of a preferred embodiment may consist of a storage server connected to a computer network upon which the recorded media layers are stored. The media layer and metadata storage unit (170) of a preferred embodiment may consist of a storage server connected to a computer network upon which synchronization, recommendation and scaling metadata is stored such as that collected in the manual user control (130). The media layer and metadata storage unit (170) of a preferred embodiment may consist of a storage server connected to a computer network upon which the time offsets and the dynamic weights are stored such as those derived in the combiner (160). An example describing a storage unit (170) should not be construed as limited to that storage unit.

In an embodiment, the data processor (180) processes the recorded media layer data to extract additional information or convert to a more desirable form depending upon the intended application. The data processor (180) of a preferred embodiment may involve a conversion of the recorded media layer data to another media representation such as between speech and text, or a time-domain signal and frequency-domain signal, or color imagery and grayscale. The data processor (180) of a preferred embodiment may involve a filter to remove interference from the concurrent playback of other media layers such as feedback from audio coming out of a speaker and back into a microphone that's recording a new audio media layer, or from recapturing the playback of the displayed video while recording overlayed video from the user. The data processor (180) of a preferred embodiment may involve a synchronization operation performed on the interfering media layers coming from the player such as data fingerprinting. An example describing a specific data processor (180) should not be construed as limited to that data processor.

FIG. 4 illustrates a flow diagram for a preferred implementation in accordance with an embodiment. One or more of the steps described below may be omitted, repeated, and/or performed in a different order. Accordingly, the specific arrangement of steps shown in FIG. 4 should not be construed as limiting the scope of the invention.

Initially, the user may select the desired media layers(s) (using the content selector 140) in accordance with an embodiment (Step 410). This selection may be entered with a keyboard into a computer or by selecting a link using a mouse or a finger on a touchscreen or any gesture input. This selection may exist in the media layer and metadata storage unit (170) or on any web site or any computer memory local to the user or on an accessible network connected storage device. In an embodiment, using a similar method of input, the user chooses whether to simply play or to simultaneously play and record (Step 420). In both cases the selected media layer(s) is (are) played (Step 430). If the selection (Step 420) is to play and record, the user may also be requested in accordance with an embodiment (Step 460) to make a selection to control the synchronization component (162) as described above to be recorded with the media layer data of the user (Step 470). In accordance with an embodiment (Step 440) the user adjusts the manual user controls (130) as entered with a keyboard into a computer or by selecting menu items using a keyboard or a finger on a touchscreen or any gesture input. In accordance with an embodiment (Step 450), the recorded data is stored to the media layer and metadata storage unit (170) and posted via the content manager (150).

In an exemplary version of the method and system an initial user, say “user_A” might record an mp3 file using the recorder 110 of the apparatus, while manually adjusting the gain level, say “gain_A”, as desired with the manual scale control 131. Since the gains discussed here could vary over the duration of their respective mp3 file, they may be represented by a series of values. In this exemplary version of the invention, the resulting mp3 file, say “mp3_A”, may then be automatically made available via the content manager 150 to the next user, say “user_B”, to be played back via 120 at a default gain, corresponding to gain_A which are accessed from the media layer and metadata storage unit (170), while synchronously recording another mp3 file, say “mp3_B”, via the recorder 110. While recording mp3_B, user_B might adjust the gain of the new mp3 file being created, say “gain_B”, as well as deviate from the default gain of mp3_A to, say, “gain_A_B” (while saving to the media layer and metadata storage unit (170) as it is being played from the player 120, providing a relative weighting in the combination of mp3_A and mp3_B with the combiner 160 to produce the social composition. In this exemplary version of the invention, recordings are isolated in the sense that the audio output, from mp3 files that are combined and played, is not audible in the mp3 file that's synchronously being recorded. This may be accomplished using headsets or hardware configurations that prevent the speaker output from being fed back into the microphone, or by using audio signal processing approaches to filter out any perceived feedback via the data processor 180. Then, in this exemplary version of the invention, if another user, say “user_C”, also wants to synchronously record an mp3 file via 110, say “mp3_C”, while playing a mixed combination of mp3_A and mp3_B (by accessing the media layer and metadata storage unit 170 and passing the data to the combiner 160), the default playback gain of mp3_B may be set by this apparatus to correspond to gain_B and the default playback gain of mp3_A may be set by this apparatus to correspond to the average of gain_A and gain_A_B via dynamic weighting 161 (perhaps incorporating normalization to prevent digital clipping or saturation). Either or both of these gains user_C might also wish to vary so that gain_B is changed to say, gain_B_C, and gain_A_B is changed to, say, gain_A_B_C, providing a relative weighting in the combination of mp3_A, mp3_B, and mp3_C to produce the social composition for others to listen or synchronously record to. This exemplary procedure could continue for any general number of users and could support playback of various combinations of mp3 files.

It should be clear from the foregoing description that the system and method provided herein affords a relatively straightforward, personalized as well as socially rewarding application for collaboration in the creation of a social composition. Various modifications and additions that can be made, without departing from the spirit and scope of this invention, will come to mind to one skilled in the art to which this invention pertains, having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. For example, audio signal processing approaches may be incorporated to transform the representation of the mp3 layers for more convenient playback using the data processor 180. One case might be to perform a phase transformation of each layer and/or placement into multiple speakers to minimize interference and allow more layers to be heard; alleviating possible negative effects during the simultaneous playback of multiple audio layers while allowing audio layers of all contributors to be heard more easily and more democratically than existing collaborative media methods and systems. Such modifications are readily apparent to one of ordinary skill. Accordingly, this description is meant to be taken only by way of example, and not to otherwise limit the scope of this invention.

The foregoing has been a detailed description of illustrative embodiments of the invention. Although specific terms are employed herein, these are used in a generic sense only and not for purposes of limitation. It will be obvious to those having skill in the art that many changes may be made to the above-described embodiments without departing from the underlying principles of the invention. The scope of the present invention should, therefore, be determined only by the following claims.

1. A networked, electronic method that allows users to generate their own media layer for availability to other users as an independent piece, or as a social composition created from this method by overlaying the user's media layer with other specified layers, or media content not necessarily generated in this method (also considered a media layer herein), the method comprising
a. a player as a means of playing either an individual media layer or an automatically generated social composition of media layers specified by the user, or media content not necessarily generated in this method;
b. a manual scale control allowing users to specify the perceptual contribution of each layer to the social composition at any time over the duration of the layers;
c. a combiner that aligns each media layer in time, scales and adds them to generate the social composition for playing;
d. a recorder to capture a new media layer for a user while semi-synchronously playing a currently available layer, or social composition, and/or other media content not necessarily generated in this method, while maintaining perceptual isolation in the recording of the user's new media layer;
e. content selector where the user specifies which available media layer(s), or other media content not necessarily generated in this method, to play and synchronize to while recording a new media layer, and to store that relationship for the method to determine which media layers are combined in the future playing of the social composition;
f. a content manager where the availability of a new media layer is announced and availability is provided to other users to play the new media layer and record in synchronization with.

2. The method according to claim 1, further comprising a recommendation component allowing users to specify a series of ratings tagged to various points of time over the duration of each media layer which are used to derive a collaborative score set for each layer.

3. The method according to claim 2, further comprising a filter to perceptually remove any contributions of other layers from the user's media layer recording.

4. The method according to claim 2, further comprising a means of dynamically weighting the perceptual contribution of each media layer over time according to its collaborative score set, whereby the level of perceptual emphasis over the duration of each layer is collaboratively varied for the playing of the social composition.

5. The method according to claim 2, further comprising a synchronization deviation specification allowing the user to input acceptable time deviations from the recorded synchronization over which the recorded media layer or portions thereof are allowed to be advanced or delayed in the additive combination of the social combination.

6. The method according to claim 2 further comprising a conversion component for converting a recorded or currently recording media layer to a different media content to be used as the new media for combining into the social composition.

7. A networked, interactive system that allows users to generate their own media layer for availability to other users from a web site, as an independent piece, or as a social composition where a computer server overlays it with other specified layers or media content not necessarily generated in this system (also considered a media layer herein), the steps comprising
a. a player as a means of playing either an individual media layer or an automatically generated social composition of media layers specified by the user, by accessing from a computer server memory over the network from a web page the desired media layers;
b. a manual scale control from a web page allowing users to specify the perceptual contribution of each layer to the social composition at any time over the duration of the layers;
c. a combiner that semi-synchronously aligns each media layer in time, scales and adds them to generate the social composition for playing;
d. a recorder to capture a new media layer for the user while semi-synchronously playing a layer, or social composition, and/or other media content not necessarily generated in this system which is available from a web page over the network in computer server memory, while maintaining perceptual isolation in the recording of the user's new media layer;
e. content selector from a web page where the user specifies which available media layer(s), or other media content not necessarily generated in this system, to play and synchronize to while recording, and to store that relationship in computer server memory for the system to determine which media layers are combined in the future playing of the social composition;
f. a content manager where the availability of a new media layer is announced and provided to network connected computer server(s) memory for other users to play and record semi-synchronously with.

8. The system according to claim 7, further comprising a recommendation component controlled from a web page while operating on the computer or on a network connected server allowing users to specify a series of ratings tagged to various points of time over the duration of each media layer which are used to automatically derive a collaborative score set for each layer.

9. The system according to claim 8, further comprising a filter operating either on the computer or on the network connected computer server to perceptually remove any contributions of other layers from the user's media layer recording.

10. The system according to claim 8, further comprising a means of dynamically weighting the perceptual contribution of each media layer over time according to its collaborative score set, whereby the level of perceptual emphasis over the duration of each layer is collaboratively varied for the playing of the social composition.

11. The system according to claim 8, further comprising a fingerprinting component to allow synchronization with media content not necessarily generated in this system or played through the same computer as the system's application or through a player that's not connected to a computer network.

12. The system according to claim 8, further comprising synchronization deviation specification allowing the user to input through a web page acceptable time deviations from the recorded synchronization over which the recorded media layer or portions thereof are allowed to be advanced or delayed in the additive combination of the social combination.

13. The system according to claim 8, further comprising a conversion component for converting a recorded or currently recording media layer to a different media content to be used as the new media for combining into the social composition.

14. A networked, interactive system that allows users to generate their own media layer with a mobile application for availability to other users over a wireless network as an independent piece, or as a social composition where a computer server overlays it with other specified layers or media content not necessarily generated in this system (also considered a media layer herein) or played through the same mobile application, the steps comprising
a. a player as a means of playing either an individual media layer or an automatically generated social composition of media layers specified by the user by accessing from a computer server memory over a wireless network the desired set of media layers;
b. a manual scale control within a mobile application allowing users to specify the perceptual contribution of each layer to the social composition at any time over the duration of the layers;
c. a combiner either on the mobile application or running on a wireless network-connected server that aligns each media layer in time, scales and adds them to generate the social composition for playing;
d. a recorder within a mobile application to capture the user's media layer while semi-synchronously playing a layer, or social composition, and/or other media content not necessarily generated in this system, using computer server memory over a wireless network, while maintaining perceptual isolation in the recording of the user's new media layer;
e. content selection from a mobile application where the user specifies which available media layer(s), or other media content not necessarily generated in this system which is available over a wireless network from computer server memory, to play and synchronize to while recording, and to store that relationship and use it in determining which media layers are combined in the future playing of the social composition;
f. a content manager, where the availability of a new media layer is automatically announced from computer server memory through a wireless network, is provided for users to play the new media layer and record in synchronization with.

15. The system according to claim 14, further comprising a recommendation component operating on a mobile application allowing users to specify a series of ratings tagged to various points of time over the duration of each media layer which are used to derive a collaborative score set for each layer.

16. The system according to claim 15, further comprising a filter operating on the mobile application or on the wireless network connected computer server to perceptually remove any contributions of other layers from the user's media layer recording.

17. The system according to claim 15, further comprising a fingerprinting component to allow synchronization with media content not necessarily generated in this system or played through the same mobile device as the system's application or through a player that's not connected to a wireless network.

18. The system according to claim 15, further comprising a means of dynamically weighting the perceptual contribution of each media layer over time according to its collaborative score set, whereby the level of perceptual emphasis over the duration of each layer is collaboratively varied for the playing of the social composition.

19. The system according to claim 15, further comprising a synchronization deviation specification input into a mobile device allowing the user to input acceptable time deviations from the recorded synchronization over which the recorded media layer portions thereof are allowed to be advanced or delayed in the additive combination of the social composition.

20. The system according to claim 15, further comprising a conversion component for converting a recorded or currently recording media layer to a different media content to be used as the new media for combining into the social composition.
